(19) United States
(12) Patent Application Publication
(10) Pub. No.: US 2013/0314819 A1
(43) Pub. Date: Nov. 28, 2013

(54) Electronic Storage System Architecture

(71) Applicants: Debjit Roy Choudhury, West Bengal (IN); Srinivasa Rao Kothamasu, Karnataka (IN); Karthik Satyanarayan Murthy Akella, Karnataka (IN)

(72) Inventors: Debjit Roy Choudhury, West Bengal (IN); Srinivasa Rao Kothamasu, Karnataka (IN); Karthik Satyanarayan Murthy Akella, Karnataka (IN)

(73) Assignee: LSI CORPORATION, Milpitas, CA (US)

(21) Appl. No.: 13/481,900

(22) Filed: May 28, 2012

(51) Int. Cl. G11B 5/004; G11B 5/127

(52) U.S. Cl. 360/100.1; 29/603.01; G9B/5.001

(57) ABSTRACT

An electronic storage system includes a first cylindrical storage area. The first cylindrical storage area is configured to rotate about an axis. The first cylindrical storage area includes a first storage surface. The storage system further includes a first access head, configured to access information stored on the first storage surface, and a first head arm. The first access head is disposed on the first head arm. A corresponding method, cylindrical storage area, and head access assembly are also provided.

### BACKGROUND

Embodiments of the invention generally relate to electronic storage systems and, more particularly, relate to multi-surface electronic storage architectures.

### SUMMARY

Embodiments of the invention include methods, devices, assemblies, and systems to increase storage density and reduce, or eliminate, the potential for head crashes in electronic storage systems.

In accordance with an embodiment of the invention, an electronic storage system is provided, which includes a first cylindrical storage area, a first access head, and a head arm. The first cylindrical storage area is configured to rotate about an axis. The first cylindrical storage area includes a first storage surface. The storage system further includes a first access head, configured to access information stored on the first storage surface, and a first head arm. The first access head is disposed on the first head arm.

In accordance with other embodiments of the invention, a corresponding method, cylindrical storage area, and head access assembly are also provided.

Embodiments of the invention will become apparent from the following detailed description, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 shows a side perspective view of a conventional hard disk drive system;

FIG. 2 shows a top view of the hard disk drive system shown in FIG. 1;

FIG. 3A shows a side perspective view of a first embodiment of an electronic storage system;

FIG. 3B shows a side perspective view of a second embodiment of the electronic storage system;

FIG. 3C shows a side perspective view of a third embodiment of the electronic storage system;

FIG. 3D shows a side perspective view of a fourth embodiment of the electronic storage system;

FIG. 4A shows a disk configuration associated with the hard disk drive system shown in FIG. 1;

FIG. 4B shows a configuration of cylindrical storage areas associated with the electronic storage system shown in FIGS. 3A and 3B; and

FIG. 5 is a block diagram depicting at least a portion of an exemplary machine in the form of a computing system configured to perform methods according to embodiments herein.

It is to be appreciated that elements in the figures are illustrated for simplicity and clarity. Common but well-understood elements that are useful in a commercially feasible embodiment are not necessarily shown in order to facilitate a less hindered view of the illustrated embodiments.

### DETAILED DESCRIPTION

Embodiments of the invention will be described in the context of methods, devices, assemblies, and systems that provide electronic information storage with increased density and a reduced potential for, or elimination of head crashes. It should be understood, however, that these embodiments are not limited to these or any other particular methods, devices, assemblies, and systems. Rather, these embodiments are more generally applicable to techniques for increasing electronic storage density and reducing malfunctions and/or errors concerning data and program integrity in electronic storage systems.

The embodiments herein increase the storage density of an electronic storage system by redefining its architecture. The architecture disclosed herein reduces the potential for head crashes, and thus reduces intervention required by additional hardware and/or software used in failsafe mechanisms. A head crash is defined herein as a hard-disk failure that occurs when a read/write head comes in contact with its corresponding rotating platter or disk. This contact results in permanent and typically irreparable damage to the magnetic media on a surface of the disk. Head crashes are most commonly caused by a sudden and/or severe motion of the disk, such as a jolt caused by dropping a laptop on the ground during operation. In addition, the embodiments herein substantially increase data transfer rates by enabling read and/or write operations to be performed simultaneously at different physical locations on multiple storage surfaces.

In conventional hard disk drive systems, the quantity of data being transferred is limited by the speed at which an actuator arm is able to move and the speed at which read/write heads are able to access data on the disks. The read/write heads are fixed to the actuator arm, and thus can only access the same physical location on each of the disks. Accordingly, access to different address locations by different read/write heads is not possible with conventional hard disk drive systems. Further, in conventional hard disk drive systems, even if data is not required from one or more of the disks, all data at the same address or physical location on each of the disks is still read.

However, in the embodiments herein, read/write heads are free to move along a vertical path independently of each other. The actuator arm, on which read/write arms are mounted, is fixed. Therefore, when a read/write head, which is mounted on the read/write arm, accesses a particular location on a particular storage surface, another read/write head is able to access a completely different physical location on a different storage surface. In this way, multiple read/write accesses are able to be performed to completely different and independent physical locations on different storage surfaces at the same time.

Embodiments of the invention are applicable to internal storage, external storage, direct-attached storage (DAS), storage area networks (SAN), and network-attached storage (NAS) systems. DAS refers to a digital storage system that is directly attached to a server or workstation without requiring a storage network disposed therebetween. DAS is primarily used to differentiate non-networked storage systems from SAN and NAS systems.

SANs are primarily used in disk arrays, tape libraries, and optical jukeboxes, which are accessible to servers. SANs enable a corresponding storage device to appear, to the operating system, to be a locally attached device. SANs typically include a dedicated network of storage devices that are not accessible through a local area network by other devices. SANs include a dedicated network that provides access to consolidated block level data storage.

NAS refers to a file-level computer data storage technique, which is connected to a computer network providing data access to heterogeneous clients. NAS operates as a file server and is specialized for this task through its hardware, software, or a configuration of these elements. NAS is often configured to be a computer appliance, which is a specialized computer configured to store and serve files rather than simply a general-purpose computer used for these functions.

FIG. 1 shows a conventional hard disk drive system 10, which includes multiple disks or platters 12 that are horizontally disposed and spaced apart from each other. The disks 12 are assigned to read/write heads 14 that are connected to a common actuator arm 16. The common actuator arm 16 moves the read/write heads 14 together as a unit. As a result, locations on two or more disks can only be accessed simultaneously if the two locations are disposed at the same relative physical location on the two or more disks.

A capacity of the hard disk drive system 10 is limited by the surface area of each disk 12 and the total quantity of disks 12. As the surface area of the disks 12 is reduced, storage density is increased by utilizing high-density disk films (not shown) covering the disks 12. The hard disk drive system 10 shown in FIG. 1 exhibits a substantial potential for head crashes due to power and/or mechanical failures. Hardware and/or software failsafe mechanisms are used to provide active protection to the disks 12 against such failures. However, these mechanisms provide significant overhead to hard disk technology in terms of space and cost. Accordingly, embodiments herein provide for a substantial increase in storage area and a reduction in or elimination of head crashes, thereby significantly reducing hardware and/or software overhead in hard disk drive systems.

Embodiments herein utilize cylindrical storage areas rather than the flat disks 12 shown in FIG. 1. Cylindrical storage areas enable the storage density of the resulting electronic storage system to be increased. Further, since read/write heads used with the cylindrical storage areas are disposed vertically, the potential for head crashes is substantially reduced or eliminated, which decreases additional hardware and/or software overhead used in failsafe mechanisms to provide active protection against these crashes. Yet further, since the read/write heads can be moved independently of each other, storage areas that are located at different physical locations on two or more cylindrical storage areas can be read and/or written simultaneously. Still further, address translation used in the embodiments herein is the same as that used in conventional hard disk drives, and thus hard disk drive controller software does not require modification to implement the embodiments herein. In addition, as with conventional, horizontally disposed disks, the cylindrical storage areas of the embodiments herein are readily divisible into tracks and sectors.

As discussed above, FIG. 1 shows a conventional hard disk drive system 10, which includes a disk assembly having disks 12 that rotate around a spindle 18. The read/write heads 14 are attached to a common actuator arm 16, which fixes the positions of the read/write heads 14 in relation to each other and controls that position relative to the disks 12.

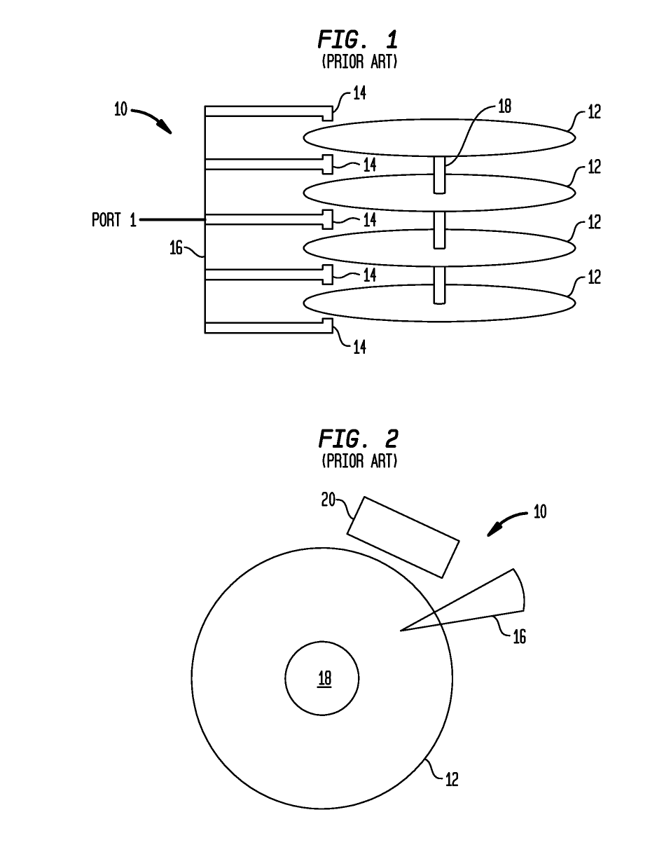

FIG. 2 shows a top view of the hard disk drive system 10 shown in FIG. 1. The hard disk drive system 10 also includes a docking area 20 that provides a resting area for the read/write heads 14, and thus actuator arm 16, when the disks 12 are not in motion and/or read/write operations are not being performed (e.g., “parking” the hard disk head(s)). The docking area 20 is used to avoid head crashes due to mechanical or power failures, and thus represents a portion of the active protection system associated with the hard disk drive system 10. Additional software (not shown) is used to control operation of the active protection system.

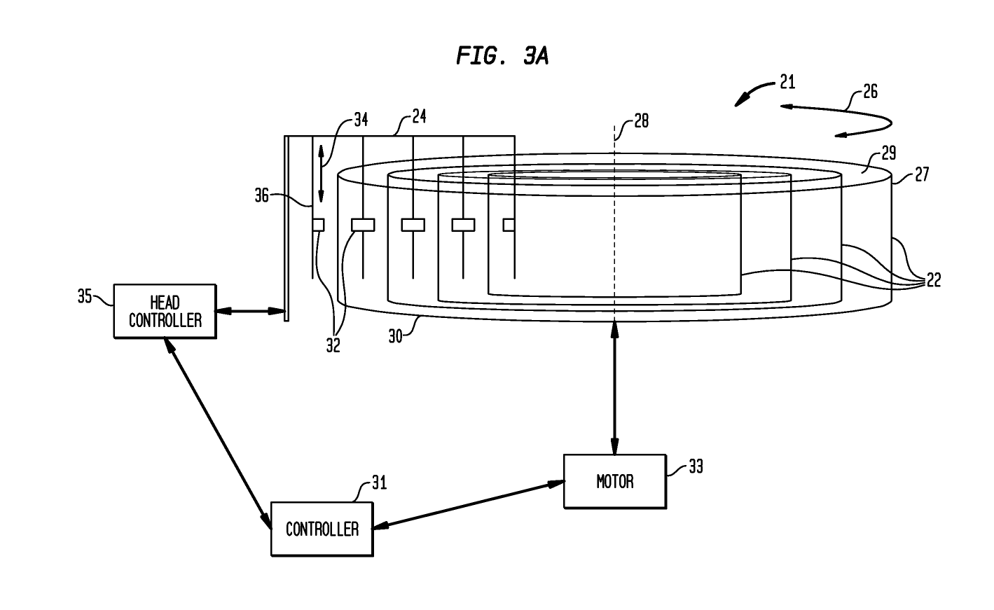

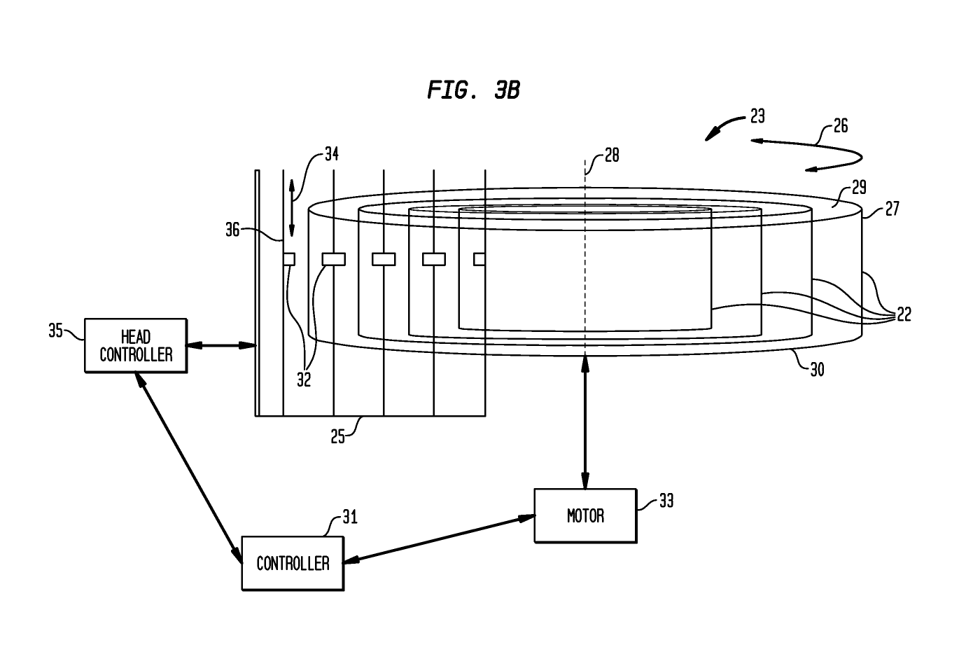

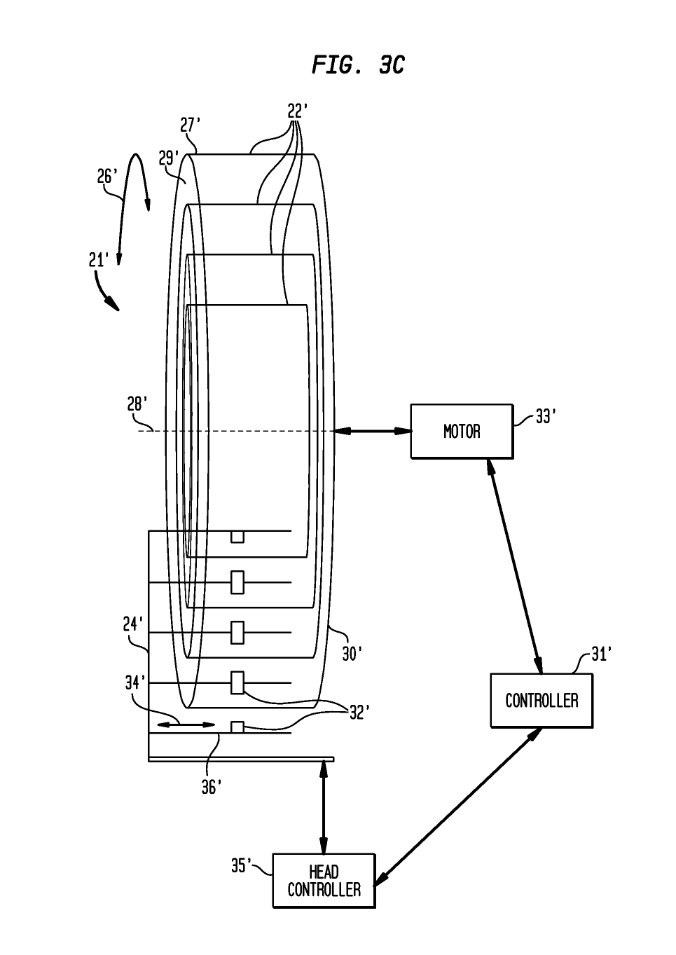

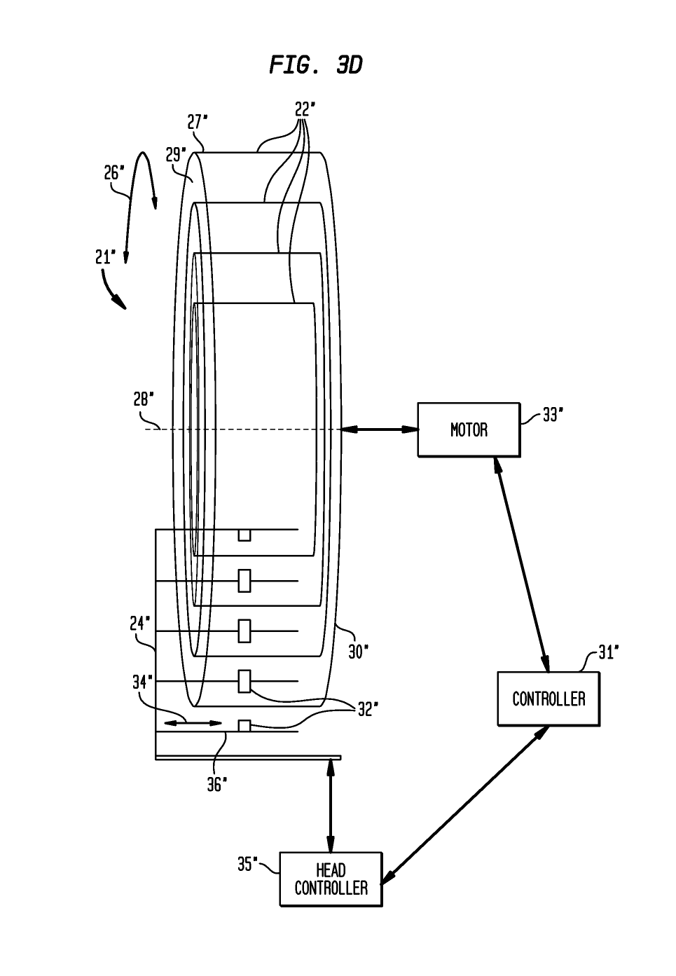

As is evident from FIGS. 1 and 2, the total storage capacity of the hard disk drive system 10 is limited by the quantity of disks 12 and the storage density of each disk 12. In addition, if the active protection system fails due to a mechanical, software, and/or electrical fault, a head crash will likely occur and the hard disk drive system 10 may be seriously damaged. As shown in FIGS. 3A and 3B, these features are not exhibited by the embodiments herein, which utilize cylindrical storage areas 22, an actuator arm 24, and head arms 36 that enable vertical motion of the read/write heads 32 in substantially vertical paths 34. The cylindrical storage areas 22 include an external surface 27 and an internal surface 29, each of which can include one or more storage areas.

FIG. 3A shows at least a portion of an exemplary electronic storage system 21, according to an embodiment of the invention, in which the circular disks 12 shown in FIGS. 1 and 2 have been replaced with cylindrical storage areas 22. The cylindrical storage areas 22 are concentrically disposed with respect to each other and rotate in directions represented by arrow 26 about a central axis 28. Rotation of the cylindrical storage areas 22, which are thin and lightweight, is possible by disposing or fixing the cylindrical storage areas 22 on a rotating base 30. Read/write heads 32 are disposed on corresponding head arms 36 and are able to move independently in substantially vertical paths indicated by arrow 34 along the corresponding head arms 36. As a result, there is no requirement for maintaining a constant air cushion between the cylindrical storage areas 22 and read/write heads 32 in order to protect against head crashes. Further, unlike the conventional hard disk drive system 10 shown in FIG. 1, the electronic storage system 21 shown in FIG. 3A does not require a docking area, which eliminates the need for an active protection system and the software and/or hardware overhead required to operate this system.

A controller 31 is coupled to a motor 33 and a head controller 35 for control of both rotation of the cylindrical storage areas 22 and read/write head 32 access to the cylindrical storage areas 22. The motor 33 is coupled, either directly or indirectly (e.g., via a belt or alternative coupling mechanism), to the base 30 and operates to control rotation of the cylindrical storage areas 22 about its central axis 28 (e.g., controlling a speed and/or direction of rotation of the storage areas 22). The head controller 35 operates to control access of the read/write heads 32 to the cylindrical storage areas 22.

FIG. 3B shows at least a portion of an alternative electronic storage system 23, according to another embodiment of the invention, which differs from the electronic storage system 21 shown in FIG. 3A primarily in its incorporation of an actuator arm 25, which is coupled to the head arms 36 below the cylindrical storage areas 22 rather than being coupled to the head arms 36 above the cylindrical storage areas 22 as shown in FIG. 3A.

FIG. 3C shows at least a portion of an alternative exemplary electronic storage system 21′, according to yet another embodiment of the invention, in which the circular disks 12 shown in FIGS. 1 and 2 have been replaced with cylindrical storage areas 22′. The cylindrical storage areas 22′ are concentrically disposed with respect to each other and rotate in directions represented by arrow 26′ about a central axis 28′. Rotation of the cylindrical storage areas 22′, which are thin and lightweight, is possible by disposing or fixing the cylindrical storage areas 22′ on a rotating base 30′. Read/write heads 32′ are disposed on corresponding head arms 36′ and are able to move independently in substantially horizontal paths indicated by arrow 34′ along the corresponding head arms 36′. Compared with the electronic storage system 21 shown in FIG. 3A, the electronic storage system 21′ is rotated by 90 degrees, such that its central axis 28′ is essentially disposed along a substantially horizontal direction. It is to be understood, however, that the invention is not limited to any specific orientation of the cylindrical storage areas 22′ or the read/write heads 32′.

FIG. 3D shows at least a portion of an alternative exemplary electronic storage system 23′, according to an embodiment of the invention, which differs from the electronic storage system 21′ shown in FIG. 3C in its incorporation of an actuator arm 25″, which is coupled to the head arms 36″ to the right of the cylindrical storage areas 22″ rather than being coupled to the head arms 36″ to the left of the cylindrical storage areas 22″ as shown in FIG. 3C. Read/write heads 32″ are disposed on corresponding head arms 36″ and are adapted to move independently in substantially horizontal paths indicated by arrow 34″ along the corresponding head arms 36″. Compared with the electronic storage system 23 shown in FIG. 3B, the electronic storage system 23′ is rotated by 90 degrees, such that its central axis 28″ is essentially disposed along a substantially horizontal direction. It is to be understood, however, that the invention is not limited to any specific orientation of the cylindrical storage areas 22″ or the read/write heads 32″.

Thus, embodiments of the cylindrical storage system illustrated in the figures are configured to rotate about a vertically disposed axis. However, in accordance with the teachings herein, one skilled in the art could develop a cylindrical storage system that is configured to rotate about a horizontally disposed axis (or an axis disposed along any other direction). In these embodiments, bearings differ by being designed for a horizontal axis of operation. The actuator arm having the read/write heads is also operated differently. For example, in a cylindrical storage system that is configured to rotate about a horizontally disposed axis, the actuator arm having the read/write heads disposed thereon remains beyond the edges of the cylindrical storage media until the cylindrical storage media reaches a rotational speed sufficient to retain a cylindrical shape, thereby having a stable position for read and write operations.

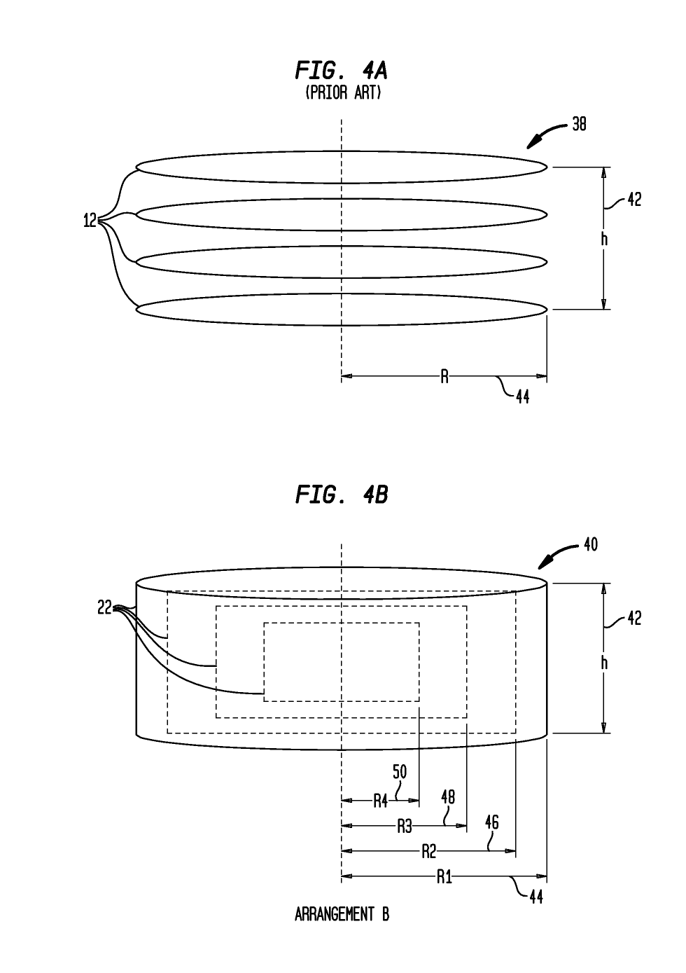

FIGS. 4A and 4B illustrate that the embodiments herein provide greater surface area, and thus more storage capacity, than the hard disk drive system 10 shown in FIGS. 1 and 2 given the same volume. FIG. 4A represents a hard disk drive configuration 38 shown in FIGS. 1 and 2, and FIG. 4B represents an electronic storage system configuration 40 shown in FIGS. 3A and 3B.

For this analysis, a height h 42 and a radius R, R1 44 are the same for both configurations 38, 40, and thus the volume occupied by configurations 38, 40 are also the same. Further, the quantity of disks 12 in configuration 38 is equal to the quantity of cylindrical storage areas 22 in configuration 40. However, it is possible to dispose a greater quantity of cylindrical storage areas 22 in electronic storage system configuration 40 than disks 12 in hard disk configuration 39, as will be discussed below.

Using the assumptions above, the total surface area for configuration 38 is provided by the following equation:

A=(storage surface(s) per disk)·(surface area per storage surface)·(quantity of disks), (1)

and the total surface area for configuration 40 is provided by the following equation:

B=(storage surface(s) per cylinder)·(surface area of all cylinders). (2)

For configuration 38, the quantity of disks 12 is equal to four (4), and for configuration 40, the quantity of cylindrical storage areas 22 is equal to four (4). As a result, the total surface area A of configuration 38 is provided by the following equation:

A=2·πR²·4, (3)

and the total surface area B of configuration 40 is provided by the following equation:

B=2·2πh(R1+R2+R3+R4). (4)

To achieve the greatest amount of spacing between any two adjacent cylinders in configuration 40, radii R1 44, R2 46, R3 48, and R4 50 are defined by the following equation:

R1= 4/3·R2=2·R3=4·R4. (5)

Therefore, the total surface area B of configuration 40 is provided by the following equation:

B=2·2πhR1(1+¾+½+¼). (6)

Accordingly, a ratio of the total surface areas for configurations 38 and 40 is provided as follows:

$$\begin{matrix}\frac{B}{A} = \frac{2 * 2 π hR 1 ( 1 + 3 / 4 + 1 / 2 + 1 / 4 )}{2 * π {R}^{2} * 4} & ( 7 ) \\ Since R = R 1 , \\ \frac{B}{A} = \frac{2 h * R * ( 10 / 4 )}{4 * {R}^{2}} & ( 8 ) \\ \frac{B}{A} = \frac{5 h}{4 R} & ( 9 )\end{matrix}$$

Thus, if the height h 42 is greater than 4R/5, where R is the outer radius of configurations 38 and 40, then the total surface area B of configuration 40 is greater than the total surface area A of configuration 38 for a given volume. Inequality (9) becomes even easier to satisfy as the quantity of cylinders is increased and the quantity of disks remains constant. For example, if the quantity of cylinders is 8, and the quantity of disks is 4, inequality (9) becomes:

$$\begin{matrix}\frac{B}{A} = \frac{2 * 2 π hR 1 ( 1 + 7 / 8 + 6 / 8 + 5 / 8 + 4 / 8 + 3 / 8 + 2 / 8 + 1 / 8 )}{2 * π {R}^{2} * 4} & ( 10 ) \\ \frac{B}{A} = \frac{2 h * R * ( 36 / 8 )}{4 * {R}^{2}} & ( 11 ) \\ \frac{B}{A} = \frac{9 h}{4 R} & ( 12 )\end{matrix}$$

which indicates that if the height h 42 is greater than 4R/9, then the total surface area B in configuration 40 is greater than the total surface area A in configuration 38 given the same volume, which is substantially easier to satisfy than inequality (9).

Typical form factors for hard disks include 5.25 inches and 3.4 inches. For example, assuming a 3.4-inch hard disk, the diameter of the disk is 3.74 inches, and the quantity of disks is generally three to five. Therefore, the radius R of the disks is provided by the following equation:

R=3.74/2=1.87 (13)

Thus, for inequality (9),

h>4R/5 (14)

h>4*1.87/5 (15)

h>1.496 inches (16)

h>38 mm. (17)

However, for inequality (12),

h>4R/9 (18)

h>4*1.87/9 (19)

h>0.83 inch (20)

h>21.01 mm. (21)

Thus, inequalities (9) and (12) indicate that as the quantity of storage surfaces increases, the constraint on height decreases. A typical 3.4-inch hard disk has a height of 25.4 mm, which is readily satisfied by inequality (12). Also, in a typical hard disk drive system, a single disk is divided into circular tracks, and a particular track in each of the disks represents a virtual cylinder. In general, the quantity of tracks per disk is on the order of hundreds to thousands. Therefore, even if the quantity of cylinders is equal to 100, the constraint on the height h 42 is substantially relaxed, which results in a significant increase in the overall storage capacity of the electronic storage system.

Thus, if the relationships between height and radius, which are a function of the quantity of cylindrical storage areas, are maintained, the total surface area and thus storage capacity is greater for configuration 40 than that of configuration 38 given the same volume. Further, as indicated above, increasing the quantity of concentric cylinders within the outer radius R, will increase the overall storage density associated with configuration 40. It is to be noted that even a small increase in surface area, such as in the order of a square millimeter, results in a substantial increase in storage capacity with respect to the embodiments herein.

In addition, configuration 40 enables the read/write heads 32 shown in FIGS. 3A and 3B to be moved independently of each other. Hence, it is possible to simultaneously access locations that are disposed at different physical positions on different cylindrical storage areas using the embodiments herein. Data being accessed in this manner is buffered and sent to a controller, thus increasing parallelism in the hard disk storage system of configuration 40. Also, the addressing mechanism used in configuration 38 need not change since the cylindrical storage areas 22, like the disks 12 in configuration 38, are able to be divided into cylinders, tracks, and sectors.

Further, in configuration 10 shown in FIG. 1, the actuator arm 16 is vertically fixed, which thereby fixes the read/write heads 14 in the vertical direction. The actuator arm 16 moves horizontally from an outer circumference towards inner regions of the disks 12. Thus, memory locations near the spindle 18 require greater access time than memory locations on the outer circumference. In configuration 10, the greatest head displacement is equal to the radius R of the disk. In contrast, in the electronic storage system 21 shown in FIG. 3A, electronic storage system 23 shown in FIG. 3B, or configuration 40 shown in FIG. 4B, the read/write heads 32 move vertically in the direction of line 34, and thus the greatest head displacement in configurations 21, 23, 40 is equal to the height h, which is on the order of 4R/5 or 4R/9 as set forth in inequalities (9) and (12). Therefore, since h is less than R, access times in configurations 21, 23, 40 are significantly less than access times in configuration 10.

Any or all of the features described herein, including those listed below, may be incorporated in one or more embodiments of the invention while remaining within the scope of this disclosure:

1. any quantity of cylindrical storage areas 22, read/write heads 32, and/or actuator arms 24 can be used;

2. any dimension of cylindrical storage area 22, read/write heads 32, and/or actuator arms 24 can be used;

3. the cylindrical storage areas 22 can be fixed and the actuator arm 24 can be movable around the cylindrical storage areas 22;

4. the cylindrical storage areas 22 and/or actuator arm 24 can be moved in a clockwise and/or counter-clockwise manner about the central axis 28;

5. any one or more of the read/write heads 32 is able to access one or more cylindrical storage area 22;

6. any one or more of the read/write heads 32 is able to access one or more storage surface associated with a cylindrical storage area; and

7. the cylindrical storage areas 22 include to one or more storage surfaces located on internal and/or external surfaces of the cylindrical storage areas.

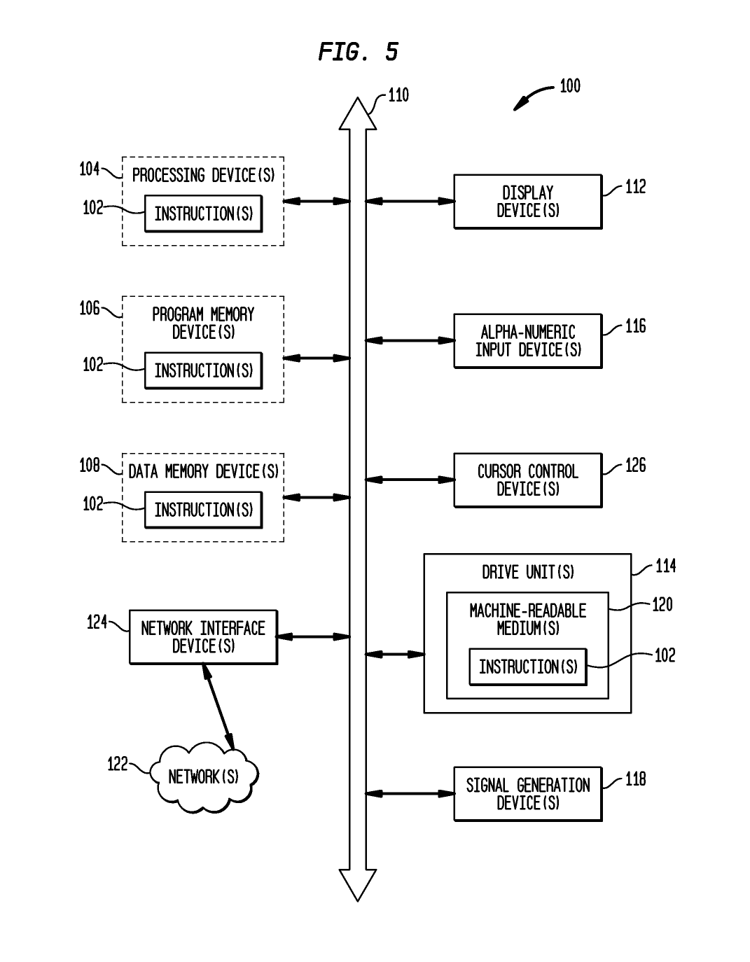

FIG. 5 is a block diagram of an embodiment of a machine in the form of a computing system 100, within which is a set of instructions 102 that, when executed, cause the machine to perform any one or more of the methodologies according to embodiments of the invention. In some embodiments, the machine operates as a standalone device. In some embodiments, the machine is connected (e.g., via a network 122) to other machines. In a networked implementation, the machine operates in the capacity of a server or a client-user machine in a server-client user network environment. Exemplary implementations of the machine as contemplated herein include, but are not limited to, a server computer, client-user computer, personal computer (PC), tablet PC, personal digital assistant (PDA), cellular telephone, mobile device, palmtop computer, laptop computer, desktop computer, communication device, personal trusted device, web appliance, network router, switch or bridge, or any machine capable of executing a set of instructions (sequential or otherwise) that specify actions to be taken by that machine.

The computing system 100 includes a processing device(s) 104 (e.g., a central processing unit (CPU), a graphics processing unit (GPU), or both), program memory device(s) 106, and data memory device(s) 108, which communicate with each other via a bus 110. The computing system 100 further includes display device(s) 112 (e.g., liquid crystals display (LCD), flat panel, solid state display, or cathode ray tube (CRT)). The computing system 100 includes input device(s) 116 (e.g., a keyboard), cursor control device(s) 126 (e.g., a mouse), disk drive unit(s) 114, signal generation device(s) 118 (e.g., a speaker or remote control), and network interface device(s) 124, operatively coupled together, and/or with other functional blocks, via bus 110.

The disk drive unit(s) 114 includes machine-readable medium(s) 120, on which is stored one or more sets of instructions 102 (e.g., software) embodying any one or more of the methodologies or functions herein, including those methods illustrated herein. The instructions 102 also reside, completely or at least partially, within the program memory device(s) 106, the data memory device(s) 108, and/or the processing device(s) 104 during execution thereof by the computing system 100. The program memory device(s) 106 and the processing device(s) 104 also constitute machine-readable media. Dedicated hardware implementations, such as but not limited to application specific integrated circuits, programmable logic arrays, and other hardware devices are configured to implement the methods described herein. Applications that include the apparatus and systems of various embodiments broadly comprise a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments, the methods, functions, or logic described herein are implemented as one or more software programs running on a computer processor. Dedicated hardware implementations including, but not limited to, application specific integrated circuits, programmable logic arrays and other hardware devices are configured to implement the methods described herein. Further, alternative software implementations including, but not limited to, distributed processing or component/object distributed processing, parallel processing, or virtual machine processing are configured to implement the methods, functions, or logic described herein.

The embodiment contemplates a machine-readable medium or computer-readable medium containing instructions 102, or that which receives and executes instructions 102 from a propagated signal so that a device connected to a network 122 can send or receive voice, video or data, and to communicate over the network 122 using the instructions 102. The instructions 102 are further transmitted or received over the network 122 via the network interface device(s) 124. The machine-readable medium also contains a data structure for storing data useful in providing a functional relationship between the data and a machine or computer in an illustrative embodiment of the systems and methods herein.

While the machine-readable medium 102 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform anyone or more of the methodologies of the embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the embodiment is considered to include anyone or more of a tangible machine-readable medium or a tangible distribution medium, as listed herein and including art-recognized equivalents and successor media, in which the software implementations herein are stored.

It should also be noted that software, which implements the methods, functions or logic herein, are optionally stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the disclosure is considered to include a tangible storage medium or distribution medium as listed herein and other equivalents and successor media, in which the software implementations herein are stored.

Although the specification describes components and functions implemented in the embodiments with reference to particular standards and protocols, the embodiments are not limited to such standards and protocols.

The illustrations of embodiments of the invention described herein are intended to provide a general understanding of the structure of the various embodiments, and they are not intended to serve as a complete description of all the elements and features of apparatus and systems that might make use of the structures described herein. Many other embodiments will become apparent to those of skill in the art upon reviewing the above description. Other embodiments are utilized and derived therefrom, such that structural and logical substitutions and changes are made without departing from the scope of this disclosure. Figures are also merely representational and are not necessarily drawn to scale. Certain proportions thereof may be exaggerated, while others diminished in order to facilitate an explanation of the embodiments of the invention. Accordingly, the specification and drawings are to be regarded in an illustrative rather than a restrictive sense.

Such embodiments of the inventive subject matter are referred to herein, individually and/or collectively, by the term “embodiment” merely for convenience and without intending to voluntarily limit the scope of this application to any single embodiment or inventive concept if more than one is in fact shown. Thus, although specific embodiments have been illustrated and described herein, it should be appreciated that any arrangement calculated to achieve the same purpose are substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single embodiment. Thus the following claims are hereby incorporated into the Detailed Description, with each claim standing on its own as a separate example embodiment.

The Abstract is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single embodiment. Thus the following claims are hereby incorporated into the Detailed Description, with each claim standing on its own as separately claimed subject matter.

Although specific example embodiments have been described, it will be evident that various modifications and changes are made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and without limitation, specific embodiments in which the subject matter are practiced. The embodiments illustrated are described in sufficient detail to enable those skilled in the art to practice the teachings herein. Other embodiments are utilized and derived therefrom, such that structural and logical substitutions and changes are made without departing from the scope of this disclosure. This Detailed Description, therefore, is not to be taken in a limiting sense, and the scope of various embodiments is defined only by the appended claims, along with the full range of equivalents to which such claims are entitled.

Given the teachings of the invention provided herein, one of ordinary skill in the art will be able to contemplate other implementations and applications of the techniques of the invention. Although illustrative embodiments of the invention have been described herein with reference to the accompanying drawings, it is to be understood that the invention is not limited to those precise embodiments, and that various other changes and modifications are made therein by one skilled in the art without departing from the scope of the appended claims.

What is claimed is:

1. An electronic storage system, the electronic storage system comprising:
a first cylindrical storage area, the first cylindrical storage area being configured to rotate about an axis, the first cylindrical storage area comprising a first storage surface;
a first access head, the first access head being configured to access information stored on the first storage surface; and
a first head arm, the first access head being disposed on the first head arm.

2. The electronic storage system, as defined by claim 1, wherein the first storage surface is disposed on an internal surface of the first cylindrical storage area.

3. The electronic storage system, as defined by claim 1, further comprising an actuator arm, the actuator arm being operatively coupled to the head arm above the first cylindrical surface.

4. The electronic storage system, as defined by claim 1, further comprising an actuator arm, the actuator arm being operatively coupled to the head arm below the first cylindrical surface.

5. The electronic storage system, as defined by claim 1, further comprising a second cylindrical storage area, the second cylindrical storage area being configured to rotate about the axis, the second cylindrical storage area comprising a second storage surface, the second cylindrical storage area being disposed concentrically with respect to the first cylindrical storage area.

6. The electronic storage system, as defined by claim 5, further comprising:
a second access head configured to access information stored on the second storage surface; and
a second head arm, the second access head being disposed on the second head arm.

7. The electronic storage system, as defined by claim 6, wherein the second head arm comprises a second longitudinal axis, the second longitudinal axis being disposed parallel to the axis, the second access head being configured to travel along the second head arm.

8. The electronic storage system, as defined by claim 1, wherein the axis is disposed one of vertically and horizontally.

9. The electronic storage system, as defined by claim 1, the first head arm comprising a first longitudinal axis, the first longitudinal axis being disposed parallel to the axis, the first access head being configured to travel along the first head arm.

10. The electronic storage system, as defined by claim 5, wherein the first access head is configured to access information stored on the second storage surface.

11. A method of manufacturing an electronic storage system, the method comprising:
configuring a first cylindrical storage area to rotate about an axis, the first cylindrical storage area comprising a first storage surface; and
configuring a first access head to access information stored on the first storage surface; and
disposing the first access head on a first head arm.

12. The method, as defined by claim 11, further comprising disposing the first storage surface on an internal surface of the first cylindrical storage area.

13. The method, as defined by claim 11, further comprising coupling an actuator arm operatively to the head arm above the first cylindrical surface.

14. The method, as defined by claim 11, further comprising coupling an actuator arm operatively to the head arm below the first cylindrical surface.

15. The method, as defined by claim 11, further comprising:
configuring a second cylindrical storage area to rotate about the axis, the second cylindrical storage area comprising a second storage surface; and
disposing the second cylindrical storage area concentrically with respect to the first cylindrical storage area;

16. The method, as defined by claim 11, further comprising:
configuring a second access head to access information stored on the second storage surface; and
disposing the second access head on a second head arm.

17. The method, as defined by claim 16, wherein the second head arm comprises a second longitudinal axis, the second longitudinal axis being disposed parallel to the axis, the second access head being configured to travel along the second head arm.

18. The method, as defined by claim 11, wherein the axis is disposed at least one of vertically and horizontally.

19. The method, as defined by claim 11, wherein the first head arm comprises a first longitudinal axis, the first longitudinal axis being disposed parallel to the axis, the first access head being configured to travel along the first head arm.

20. The method, as defined by claim 15, further comprising configuring the first access head to access information stored on the second storage surface.

21. A first cylindrical storage area for use in an electronic storage system, the first cylindrical storage area comprising a first storage surface, the first storage surface being configured to store information, the first cylindrical storage area being configured to rotate about an axis, the first storage surface being configured to be accessed by a first access head configured to move along a head arm.

22. The first cylindrical storage area, as defined by claim 21, wherein the first cylindrical storage area is configured to operate with a second cylindrical storage area disposed concentrically with respect to the first cylindrical storage area, the second cylindrical storage area being configured to rotate about the axis, the second cylindrical storage area comprising a second storage surface.

23. The first cylindrical storage area, as defined by claim 21, wherein the first storage surface is disposed on an internal surface of the first cylindrical storage area.

24. The first cylindrical storage area, as defined by claim 21, wherein the axis is disposed at least one of vertically and horizontally.

25. A head access assembly for use in an electronic storage system, the head access assembly comprising:
a first access head configured to access information stored on a first storage surface of a first cylindrical storage area configured to rotate about an axis;
a first head arm, the first access head being disposed on the first head arm, the first access head being configured to travel along the first head arm.

26. The head access assembly, as defined by claim 25, further comprising an actuator arm, the actuator arm being operatively coupled to the first head arm above the first cylindrical surface.

27. The head access assembly, as defined by claim 25, further comprising an actuator arm, the actuator arm being operatively coupled to the first head arm below the first cylindrical surface.

28. The head access assembly, as defined by claim 25, further comprising:
a second access head configured to access information stored on a second storage surface of a second cylindrical storage area configured to rotate about the axis concentrically with respect to the first cylindrical storage surface; and
a second head arm, the second access head being disposed on the second head arm.

29. The head access assembly, as defined by claim 28, wherein the first access head is configured to access information stored on the second storage surface.

30. The head access assembly, as defined by claim 28, wherein the second head arm comprises a second longitudinal axis, the second longitudinal axis being disposed parallel to the axis, the
second access head being configured to travel along the second head arm.
